(19) United States
(12) Patent Application Publication
(10) Pub. No.: US 2024/0338683 A1
(43) Pub. Date: Oct. 10, 2024

(54) System and Method for Token-based Transaction Processing

(71) Applicant: Nuance Communications, Inc., Burlington, MA (US)

(72) Inventors: Aviram Fireberger, Kibbutz Karmia (IS); Hadas Bitran, Ramat Hasharon (IS); Guy Epshtein, Hasharon (IT)

(21) Appl. No.: 18/296,716

(22) Filed: Apr. 6, 2023

(51) Int. Cl. G06Q 20/38

(52) U.S. Cl. CPC G06Q 20/38

(57) ABSTRACT

A method, computer program product, and computing system for identifying a token associated with data previously processed by a data processing service. In response to identifying the token, a subset of processing functionality not performed by the data processing service previously is determined. The data is processed with the subset of processing functionality not performed by the data processing service previously.

### BACKGROUND

Data is often sent to a data processing service for processing (e.g., images or text for information extraction). However, the data may be provided for repeated processing due to changes in the data processing service. However, data processing services are stateless and do not track or record when the same data has already been processed. Accordingly, all the data needs to go through re-processing even if the data has not changed, and when the service consumption model is by transactions/by amount of data sent, users pay again to re-process the same data.

### BRIEF DESCRIPTION OF THE DRAWINGS

FIG. 1 is a flow chart of one implementation of the token-based transaction process;

FIG. 2 is a diagrammatic view of the generation of a token during processing of input data using a data processing service in accordance with one implementation of the token-based transaction process;

FIG. 3 is a diagrammatic view of the validation of a token during subsequent processing of input data using a data processing service in accordance with one implementation of the token-based transaction process;

FIG. 4 is a diagrammatic view of a computer system and the token-based transaction process coupled to a distributed computing network.

Like reference symbols in the various drawings indicate like elements.

### DETAILED DESCRIPTION OF THE PREFERRED EMBODIMENTS

As will be discussed in greater detail below, implementations of the present disclosure generate and validate a token associated with the processing of data by a data processing service to identify efficiencies during subsequent re-processing of the same data. For example, a data processing service is a software-based algorithm or model that collects and manipulates input data to generate a result. Examples of data processing services include image-processing services (e.g., medical image processing services, image enhancement services, image editing services, etc.); speech processing services (e.g., automated speech recognition (ASR), biometric verification, speech enhancement, etc.); and/or text processing services (e.g., translation services, chat-based query processing, text summarization services, etc.). Data processing services are stateless and generally do not retain or reference previously processed data. As noted above, data is sometimes re-processed (e.g., due to changes in the data processing service, initial limited processing selection, etc.). Accordingly, all the data needs to go through re-processing even if the data has not changed. As will be described in greater detail below, a token is generated when data is processed during a first transaction and used during a subsequent transaction to determine what processing functionality of the data processing service has already been provided. Processing functionality that has not been provided by the data processing service is determined using the token and is used to process the data. In this manner, subsequent re-processing of the data is limited to the processing functionality that has not already been provided by the data processing service—enhancing the efficiency of the data processing service and avoiding costly re-processing of the data for results previously provided during earlier processing.

The details of one or more implementations are set forth in the accompanying drawings and the description below. Other features and advantages will become apparent from the description, the drawings, and the claims.

### The Token-Based Transaction Process:

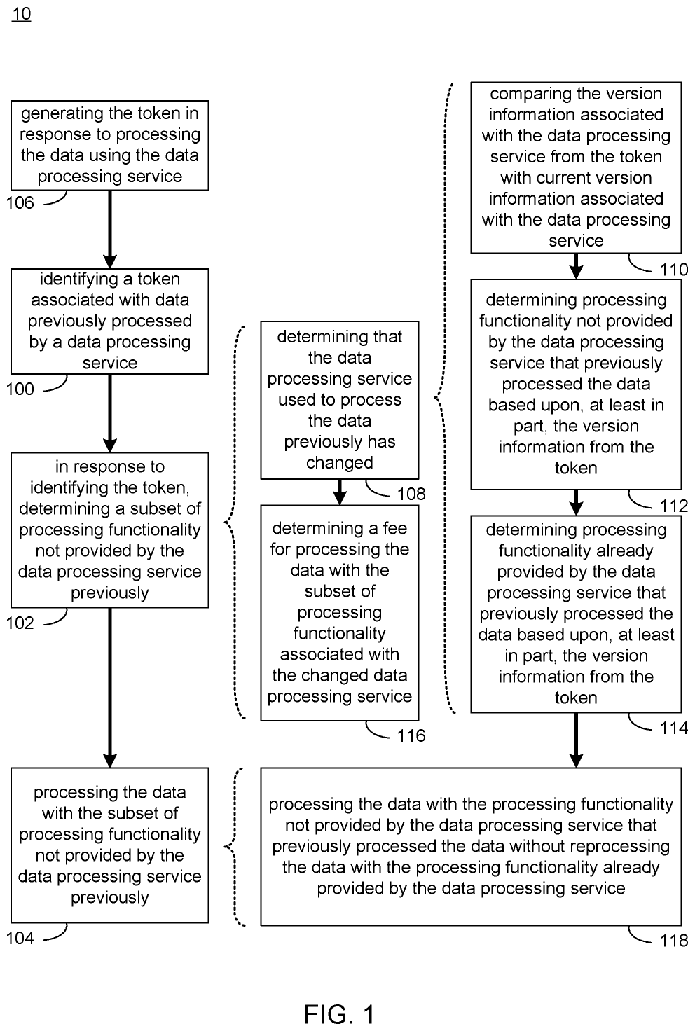

Referring also to FIGS. 1-4, token-based transaction process 10 identifies 100 a token associated with data previously processed by a data processing service. In response to identifying the token, a subset of processing functionality not performed by the data processing service previously is determined 102. The data is processed 104 with the subset of processing functionality not performed by the data processing service previously.

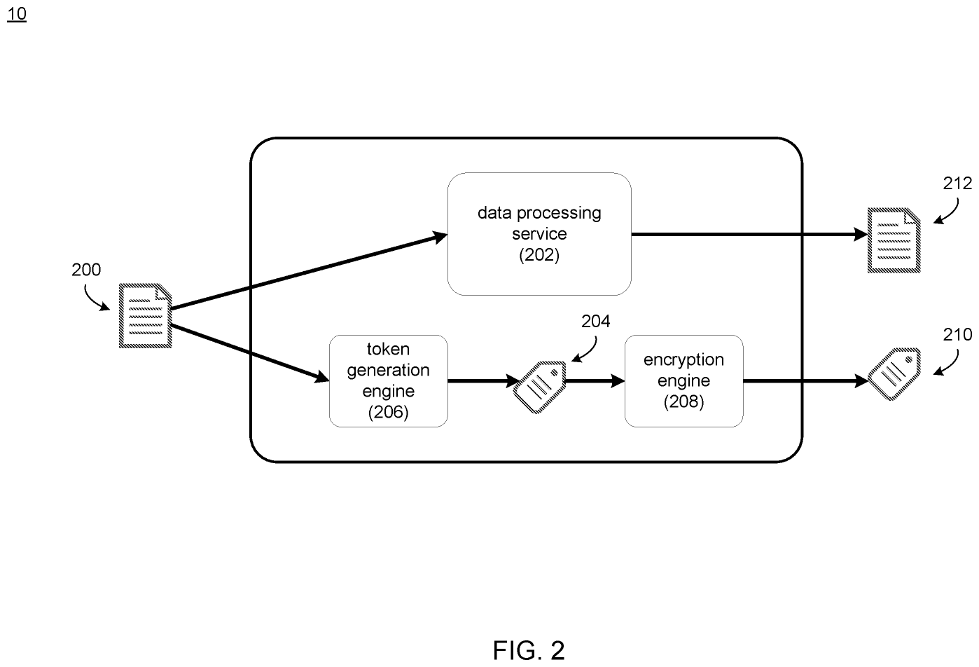

In some implementations, token-based transaction process 10 generates 106 a token in response to processing data using a data processing service during a first transaction. Referring also to FIG. 2, the generation of a token is shown. For example, suppose input data (e.g., data 200) is provided to a data processing service (e.g., data processing service 202) for processing. A data processing service (e.g., data processing service 200) is a software-based algorithm or model that collects and manipulates input data to generate a result. As shown in FIG. 2, in addition to processing data 200 using data processing service 202, token-based transaction process 10 generates 106 a token (e.g., token 204) using a token generation engine (e.g., token generation engine 206). A token generation engine (e.g., token generation engine 206) is a software-based algorithm or model that generates a token (e.g., token 204) associated with the input data (e.g., data 200). In one example, token 204 is generated 106, using token generation engine 206, by hashing data 200 to a constant hash length. Accordingly, and in this example, token 204 is a hash representation of data 200. In some implementations, token-based transaction process 10 generates 106 token 104 using a hash function with a “secret salt” (i.e., random data that is used as an additional input to the hash function) that the service owner would save in the service's secrets storage such as key vault in order to increase protection against fraud and abuse attempt.

In some implementations, the token includes version information associated with the data processing service. For example, token-based transaction process 10 generates 106 token 204 with various portions of information concerning data 200. In one example, token-based transaction process 10 generates 106 token 204 with the date, version information associated with data processing service 202 at the time of the transaction, subscription identifier, and other service metadata associated with the transaction. As will be discussed in greater detail below, version information associated with data processing service 202 includes a description or reference to processing functionality associated with data processing service 202 at the time data 200 is processed during this transaction (i.e., processing of data 200 using data processing service 202).

Suppose data processing service 202 is a medical image recognition service for identifying particular medical features from images. In this example, version information associated with data processing service 202 includes a version number and/or a description of or reference to features data processing service 202 is trained to identify. Specifically, suppose that data processing service 202 includes the ability to perform ten unique tests on data 200 to identify particular medial features. Accordingly, token 204 includes version information indicative of the ten unique tests data processing service 202 performed on data 200. In some implementations, data processing service 202 does not retain or record any transaction information associated with processing data 200. Accordingly, token 204 retains this state information associated with data processing service 202 when processing data 200.

In some implementations, token-based transaction process 10 encrypts token 204 to generate encrypted token 210 using an encryption engine (e.g., encryption engine 208). Encryption engine 208 encrypts token 204 using a secret key preserved in a service key vault associated with data processing service 202. The output of the encryption is the encrypted token 210 that is provided or returned to the user that provided data 200. As noted above, data processing service 202 generates a result (e.g., result 212) that is independent of token 210. In this manner, data processing service 202 is not modified when generating 106 token 204.

In some implementations, token-based transaction process 10 identifies 100 a token associated with data previously processed by a data processing service. For example, suppose data processing service 202 receives a request to process data 200 in a subsequent transaction. As discussed above, data processing service 202 does not retain records or logs to indicate that data 200 has previously been processed. Accordingly, without validating token 210, data processing service 202 would simply re-process data 200 with the same processing functionality as before. However, by validating token 210, token-based transaction process 10 allows data processing service 202 to avoid re-processing data 200 again in its entirety (i.e., using its entire processing functionality). Rather, data processing service 200 uses token 210 to determine which processing functionality has not already been performed on data 200 and, as will be discussed in greater detail below, processes 104 data 200 with the subset of processing functionality not already performed on data 200.

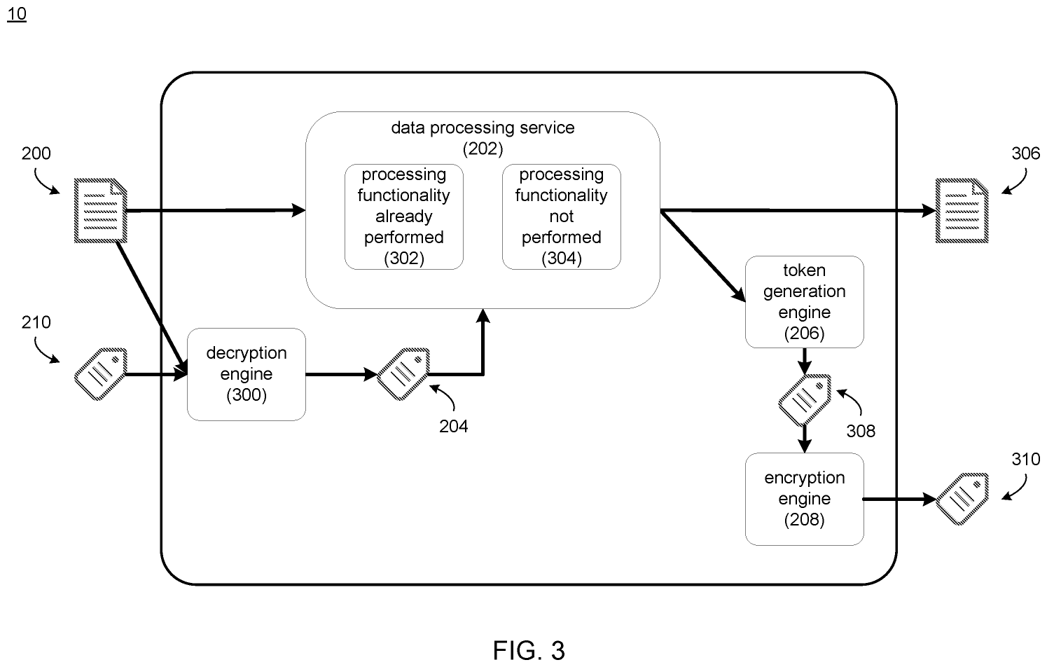

Referring also to FIG. 3, token-based transaction process 10 identifies 100 token 210 by determining whether data 200 is provided with a token. If no token is provided, data processing service 202 processes data 200 in its normal manner by processing data 200 with the entirety of its processing functionality as requested by the user. If a token is provided, identifying 100 token 210 includes decrypting the attached token (e.g., token 210) using the data processing service's secret key. As shown in FIG. 3, decryption engine 300 decrypts encrypted token 210 into token 204. A decryption engine (e.g., decryption engine 300) is a software-based algorithm or model that processes input tokens using its secret key to decrypt the token.

In some implementations, token-based transaction process 10 uses token 210 to determine if data 200 has been processed by data processing service 202 previously. For example, and in some implementations, token 204 includes a hash of the data previously processed by the data processing service. Accordingly, token-based transaction process 10 performs a hash of data 200 with the same function (and secret salt, as applicable) that was used to generate token 204 as shown in FIG. 2. In the example of a hashing operation to generate token 204, token-based transaction process 10 compares the decrypted hash to the new/run-time hash of data 200. If the hash is different, token-based transaction process 10 fails the transaction and processes data 200 normally. In other words, if the comparison of the hash of data 200 and token 204 is not the same, this indicates that data 200 as shown in FIG. 3 has not been processed by data processing service 202 in a previous transaction. However, and as will be discussed in greater detail below, in response to determining that the request to process data 200 is a re-processing transaction, token-based transaction process 10 determines processing functionality not already performed on data 200 to generate a previous result (e.g., result 212).

In some implementations and in response to identifying the token, token-based transaction process 10 determines 102 a subset of processing functionality not performed by the data processing service previously. For example, and as discussed above, when processing data 200, data processing service 202 is stateless and, as such, does not retain records or logs of processing any particular data. Accordingly, data processing service 202 could be provided with the same data and provide the same result each time the data is processed. In this manner, data processing service is processing the data with the same processing functionality. However, suppose data 200 is processed by data processing service 202 with a subset of its processing functionality. For example, suppose that a user only requested certain processing functionality when data 200 was processed previously (e.g., in a first transaction). In another example, suppose data process service 202 is upgraded with new processing functionality after the first transaction. In each of these examples, there is processing functionality not performed by data processing service 202 on data 200 in a previous transaction and processing functionality that need not be performed again.

In some implementations, determining 102 a subset of processing functionality not performed by the data processing service previously includes determining 108 that the data processing service used to process the data previously has changed. For example, suppose data processing service 202 includes processing functionality (e.g., functionality or features that generate the result). In one example, suppose data processing service 202 is upgraded (i.e., changed) to include new processing functionality. In this example, data processing service 202's upgrade may be represented as a change in version where the previous version of data processing service 202 has one set of processing functionality and the new version of data processing service 202 has new or upgraded processing functionality in addition to any unchanged processing functionality from the previous version. Accordingly, token-based transaction process 10 may use token 204 to determine 108 whether data processing service 202 has changed since a previous transaction involving data 200.

In some implementations, determining 108 that the data processing service has changed includes comparing 110 the version information associated with the data processing service from the token with current version information associated with the data processing service. For example and as shown in FIG. 2, suppose that data processing service 202 processes data 200 in a first transaction with a first set of processing functionality (e.g., performing ten unique tests on data 200 to identify particular medial features) and token 210 is generated with version information indicative of ten unique tests. Now, suppose that data processing service 202 is upgraded to perform two additional unique tests to identify particular medical features. When data 200 is provided along with token 210 to data processing service 202 in a subsequent transaction, token-based transaction process 10 compares 110 the version information associated with data processing service 202 and current version information. In this example, because the current version information is different, token-based transaction process 10 determines that data processing service 202 has changed (i.e., been updated) at some point in time after the transaction that created token 210.

In some implementations, determining 102 a subset of processing functionality not performed by the data processing service previously includes: determining 112 processing functionality not performed by the data processing service that previously processed the data based upon, at least in part, the version information from the token; and determining 114 processing functionality already performed by the data processing service that previously processed the data based upon, at least in part, the version information from the token. Continuing with the above example, suppose token-based transaction process 10 compares 110 the version information from token 210 and the current version information to determine that data processing service 202 has changed since the first transaction in which token 210 was generated. Accordingly, token-based transaction process 10 determines 112 processing functionality not performed by data processing service 202 and determines 114 processing functionality already performed by data processing service 202. As shown in FIG. 3, data processing service 202 includes processing functionality already performed 302 and processing functionality not performed 304. In this example, token-based transaction process 10 determines 112 that the two new tests define the processing functionality not performed (e.g., processing functionality not performed 304) and determines 114 that the ten tests of the previous version of data processing service 202 define the processing functionality already performed (e.g., processing functionality already performed 302).

In some implementations, token-based transaction process 10 determines 116 a fee for processing the data with the subset of processing functionality associated with the changed data processing service. For example, in response to determining 102 a subset of processing functionality not performed by the data processing service previously, token-based transaction process 10 determines a fee for processing the data with the subset of processing functionality. Suppose that during the first transaction as shown in FIG. 2, token-based transaction process 10 determines a processing fee per test on the medical imagery. In the example with ten unique tests, the processing fee is ten multiplied by the processing fee per test. In a subsequent transaction (as shown in FIG. 3), token-based transaction process 10 determines that only two new tests have yet to be performed on data 200 (e.g., processing functionality not performed 304). Accordingly, instead of generating a fee of twelve multiplied by the processing fee per test, token-based transaction process 10 determines 116 a fee of two multiplied by the processing fee per test (e.g., for the two new tests not previously performed on data 200). In some implementations, token-based transaction process 10 may determine 116 the fee for processing the data with the subset of processing functionality as the fee for processing data 200 at the time of the second transaction subtracted from the fee for processing data 200 at the time of the first transaction defined by token 210. In this manner, token-based transaction process 10 accounts for changes in fee structures over time by comparing fees charged in various versions and credits previous fee payments during previous transactions.

In some implementations, token-based transaction process 10 processes 104 the data with the subset of processing functionality not performed by the data processing service previously. Continuing with the above example, suppose token-based transaction process 10 determines 112 that the two new tests added in the upgrade to data processing service 202 define the processing functionality not performed (e.g., processing functionality not performed 304). Accordingly, token-based transaction process 10 processes data 200 with the subset of processing functionality (e.g., processing functionality not performed 304) using data processing service 202. In this example, data processing service 202 generates a new result (e.g., result 306).

In some implementations, processing 104 the data with the subset of processing functionality includes processing 118 the data with the processing functionality not performed by the data processing service that previously processed the data without reprocessing the data with the processing functionality already performed by the data processing service. For example, instead of re-processing data 200 in its entirety (e.g., using all processing functionality of data processing service 202), token-based transaction process 10 processes 118 data 202 with processing functionality not performed 304 without re-processing data 200 with processing functionality already performed 302. For example, result 306 includes results of processing functionality not performed 304 while result 212 includes results of processing functionality already performed 302. In this manner, token-based transaction process 10 conserves computing resources by using a token generated during a previous transaction to determine processing functionality not performed in the previous transaction. Accordingly, token-based transaction process 10 allows more efficient use of data processing service 202 by forgoing repetitive processing of the same data in different transactions.

In some implementations and in response to processing 104 data 200 with the subset of processing functionality not performed previously, token-based transaction process 10 generates a new token (e.g., token 308) using token generation engine 206 as discussed above. Similarly, token-based transaction process 10 uses encryption engine 208 to generate encrypted token 310. With encrypted token 310, subsequent transactions involving data 200 and data processing service 202 may be improved by avoiding unnecessary re-processing of data 200.

### System Overview:

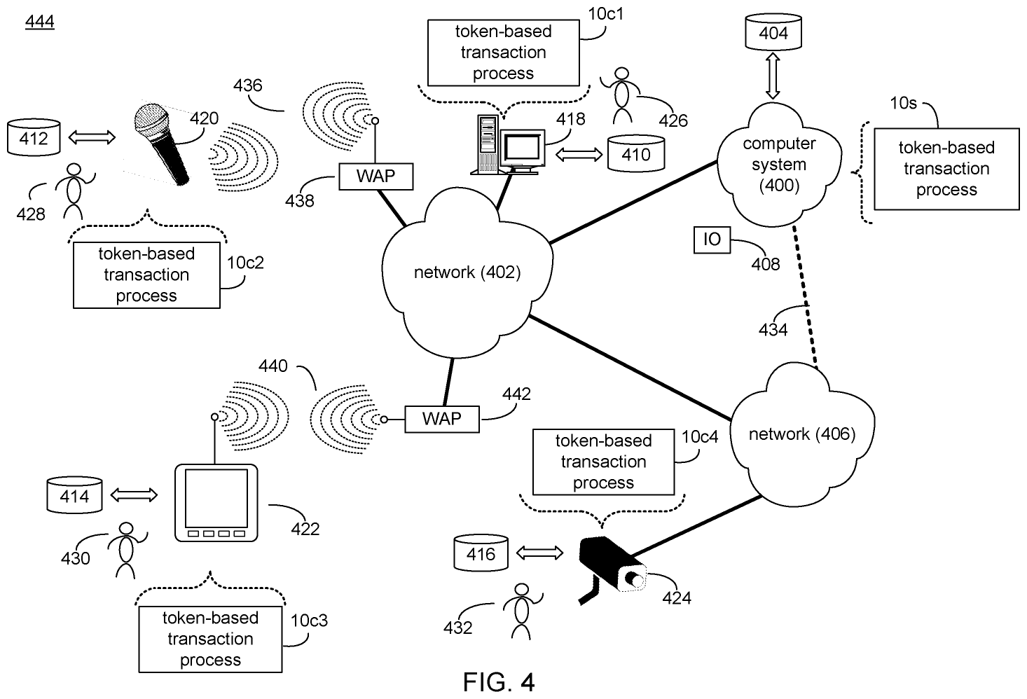

Referring to FIG. 4, there is shown token-based transaction process 10. Token-based transaction process 10 may be implemented as a server-side process, a client-side process, or a hybrid server-side/client-side process. For example, token-based transaction process 10 may be implemented as a purely server-side process via token-based transaction process 10s. Alternatively, token-based transaction process 10 may be implemented as a purely client-side process via one or more of token-based transaction process 10cl, token-based transaction process 10c2, token-based transaction process 10c3, and token-based transaction process 10c4. Alternatively still, token-based transaction process 10 may be implemented as a hybrid server-side/client-side process via token-based transaction process 10s in combination with one or more of token-based transaction process 10c1, token-based transaction process 10c2, token-based transaction process 10c3, and token-based transaction process 10c4.

Accordingly, token-based transaction process 10 as used in this disclosure may include any combination of token-based transaction process 10s, token-based transaction process 10cl, token-based transaction process 10c2, token-based transaction process 10c3, and token-based transaction process 10c4.

Token-based transaction process 10s may be a server application and may reside on and may be executed by a computer system 400, which may be connected to network 402 (e.g., the Internet or a local area network). Computer system 400 may include various components, examples of which may include but are not limited to: a personal computer, a server computer, a series of server computers, a mini computer, a mainframe computer, one or more Network Attached Storage (NAS) systems, one or more Storage Area Network (SAN) systems, one or more Platform as a Service (PaaS) systems, one or more Infrastructure as a Service (IaaS) systems, one or more Software as a Service (SaaS) systems, a cloud-based computational system, and a cloud-based storage platform.

A SAN includes one or more of a personal computer, a server computer, a series of server computers, a mini computer, a mainframe computer, a RAID device and a NAS system. The various components of computer system 400 may execute one or more operating systems.

The instruction sets and subroutines of token-based transaction process 10s, which may be stored on storage device 404 coupled to computer system 400, may be executed by one or more processors (not shown) and one or more memory architectures (not shown) included within computer system 400. Examples of storage device 404 may include but are not limited to: a hard disk drive; a RAID device; a random access memory (RAM); a read-only memory (ROM); and all forms of flash memory storage devices.

Network 402 may be connected to one or more secondary networks (e.g., network 404), examples of which may include but are not limited to: a local area network; a wide area network; or an intranet, for example.

Various IO requests (e.g., IO request 408) may be sent from token-based transaction process 10s, token-based transaction process 10ci, token-based transaction process 10c2, token-based transaction process 10c3 and/or token-based transaction process 10c4 to computer system 400. Examples of IO request 408 may include but are not limited to data write requests (i.e., a request that content be written to computer system 400) and data read requests (i.e., a request that content be read from computer system 400).

The instruction sets and subroutines of token-based transaction process 10cl, token-based transaction process 10c2, token-based transaction process 10c3 and/or token-based transaction process 10c4, which may be stored on storage devices 410, 412, 414, 416 (respectively) coupled to client electronic devices 418, 420, 422, 424 (respectively), may be executed by one or more processors (not shown) and one or more memory architectures (not shown) incorporated into client electronic devices 418, 420, 422, 424 (respectively). Storage devices 410, 412, 414, 416 may include but are not limited to: hard disk drives; optical drives; RAID devices; random access memories (RAM); read-only memories (ROM), and all forms of flash memory storage devices. Examples of client electronic devices 418, 420, 422, 424 may include, but are not limited to, personal computing device 418 (e.g., a smart phone, a personal digital assistant, a laptop computer, a notebook computer, and a desktop computer), audio input device 420 (e.g., a handheld microphone, a lapel microphone, an embedded microphone (such as those embedded within eyeglasses, smart phones, tablet computers and/or watches) and an audio recording device), display device 422 (e.g., a tablet computer, a computer monitor, and a smart television), machine vision input device 424 (e.g., an RGB imaging system, an infrared imaging system, an ultraviolet imaging system, a laser imaging system, a SONAR imaging system, a RADAR imaging system, and a thermal imaging system), a hybrid device (e.g., a single device that includes the functionality of one or more of the above-references devices; not shown), an audio rendering device (e.g., a speaker system, a headphone system, or an earbud system; not shown), various medical devices (e.g., medical imaging equipment, heart monitoring machines, body weight scales, body temperature thermometers, and blood pressure machines; not shown), and a dedicated network device (not shown).

Users 426, 428, 430, 432 may access computer system 400 directly through network 402 or through secondary network 406. Further, computer system 400 may be connected to network 402 through secondary network 406, as illustrated with link line 434.

The various client electronic devices (e.g., client electronic devices 418, 420, 422, 424) may be directly or indirectly coupled to network 402 (or network 406). For example, personal computing device 418 is shown directly coupled to network 402 via a hardwired network connection. Further, machine vision input device 424 is shown directly coupled to network 406 via a hardwired network connection. Audio input device 422 is shown wirelessly coupled to network 402 via wireless communication channel 436 established between audio input device 420 and wireless access point (i.e., WAP) 438, which is shown directly coupled to network 402. WAP 438 may be, for example, an IEEE 802.11a, 802.11b, 802.11g, 802.11n, Wi-Fi™, and/or Bluetooth™ device that is capable of establishing wireless communication channel 436 between audio input device 420 and WAP 438. Display device 422 is shown wirelessly coupled to network 402 via wireless communication channel 440 established between display device 422 and WAP 442, which is shown directly coupled to network 402.

The various client electronic devices (e.g., client electronic devices 418, 420, 422, 424) may each execute an operating system, wherein the combination of the various client electronic devices (e.g., client electronic devices 418, 420, 422, 424) and computer system 400 may form modular system 444.

### General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be used. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object-oriented programming language. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet.

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general-purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, not at all, or in any combination with any other flowcharts depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method, executed on a computing device, comprising:
identifying a token associated with data previously processed by a data processing service;
in response to identifying the token, determining a subset of processing functionality not performed by the data processing service previously; and
processing the data with the subset of processing functionality not performed by the data processing service previously.

2. The computer-implemented method of claim 1, wherein the token includes a hash of the data previously processed by the data processing service.

3. The computer-implemented method of claim 1, wherein the token includes version information associated with the data processing service.

4. The computer-implemented method of claim 3, wherein determining a subset of processing functionality not performed by the data processing service previously includes determining that the data processing service used to process the data previously has changed.

5. The computer-implemented method of claim 4, wherein determining that the data processing service has changed includes comparing the version information associated with the data processing service from the token with current version information associated with the data processing service.

6. The computer-implemented method of claim 5, wherein determining a subset of processing functionality not performed by the data processing service previously includes:
determining processing functionality not performed by the data processing service that previously processed the data based upon, at least in part, the version information from the token; and
determining processing functionality already performed by the data processing service that previously processed the data based upon, at least in part, the version information from the token.

7. The computer-implemented method of claim 1, wherein processing the data with the subset of processing functionality includes processing the data with the processing functionality not performed by the data processing service that previously processed the data without reprocessing the data with the processing functionality already performed by the data processing service.

8. A computing system comprising:
a memory; and
a processor to identify a token associated with data previously processed by a data processing service, to determine that the data processing service used to process the data previously has changed, to determine a subset of processing functionality associated with the changed data processing service, and to process the data with the subset of processing functionality associated with the changed data processing service.

9. The computing system of claim 8, wherein the token includes a hash of the data previously processed by the data processing service.

10. The computing system of claim 8, wherein the token includes version information associated with the data processing service.

11. The computing system of claim 10, wherein determining that the data processing service has changed includes comparing the version information associated with the data processing service from the token with current version information associated with the data processing service.

12. The computing system of claim 11, wherein determining a subset of processing functionality associated with the changed data processing service includes:
determining processing functionality not performed by the data processing service that previously processed the data based upon, at least in part, the version information from the token; and
determining processing functionality already performed by the data processing service that previously processed the data based upon, at least in part, the version information from the token.

13. The computing system of claim 12, wherein processing the data with the subset of processing functionality includes processing the data with the processing functionality not performed by the data processing service that previously processed the data without reprocessing the data with the processing functionality already performed by the data processing service.

14. The computing system of claim 8, further comprising:
generating the token in response to processing the data using the data processing service.

15. A computer program product residing on a non-transitory computer readable medium having a plurality of instructions stored thereon which, when executed by a processor, cause the processor to perform operations comprising:
identifying a token associated with data previously processed by a data processing service;
in response to identifying the token, determining that the data processing service used to process the data previously has changed;
determining a subset of processing functionality associated with the changed data processing service;
determining a fee for processing the data with the subset of processing functionality associated with the changed data processing service; and
processing the data with the subset of processing functionality associated with the changed data processing service.

16. The computer program product of claim 15, wherein the token includes version information associated with the data processing service.

17. The computer program product of claim 16, wherein determining that the data processing service has changed includes comparing the version information associated with the data processing service from the token with current version information associated with the data processing service.

18. The computer program product of claim 15, wherein determining a subset of processing functionality associated with the changed data processing service includes:
determining processing functionality not performed by the data processing service that previously processed the data based upon, at least in part, the version information from the token; and
determining processing functionality already performed by the data processing service that previously processed the data based upon, at least in part, the version information from the token.

19. The computer program product of claim 18, wherein processing the data with the subset of processing functionality includes processing the data with the processing functionality not performed by the data processing service that previously processed the data without reprocessing the data with the processing functionality already performed by the data processing service.

20. The computer program product of claim 15, wherein the fee for processing the data with the subset of processing functionality is a portion of a total fee for processing the data with all processing functionalities of the data processing service.
